(19) United States
(12) Patent Application Publication
(10) Pub. No.: US 2018/0039618 A1
(43) Pub. Date: Feb. 8, 2018

(54) COMPUTERIZED GROUP TASK DIGITAL ASSISTANCE

(71) Applicant: Microsoft Technology Licensing, LLC, Redmond, WA (US)

(72) Inventors: Arun Kumar, Hyderabad (IN); Rohit Mani, Hyderabad (IN); Sasanka Madiraju, Hyderabad (IN); Pragya Mehta, Hyderabad (IN); Bhavesh Sharma, Hyderabad (IN); Rahul Gupta, Hyderabad (IN); Deepinder Gill, Hyderabad (IN)

(73) Assignee: Microsoft Technology Licensing, LLC, Redmond, WA (US)

(21) Appl. No.: 15/230,967

(22) Filed: Aug. 8, 2016

(51) Int. Cl. G06F 17/27; G06F 3/0482; H04L 12/58; G06F 3/0484

(52) U.S. Cl. CPC G06F 17/279; G06F 3/04842; G06F 3/0482; H04L 51/02; H04L 51/18

(57) ABSTRACT

A digital conversational bot can be joined in a natural language group conversation between profiles over a computer conversation platform. A recommendation option set of multiple options can be generated from an initial option set. The identifying can include analyzing the initial option set using individual data of the profiles pertaining to the task. Also, a natural language script can be generated and transmitted to the profiles via the digital conversational bot as part of the group conversation, with the natural language script describing the options of the recommendation option set. A group consensus of the profiles in selecting a group selected option from the recommendation option set can be facilitated via the digital conversational bot. Additionally, assistance in completion of the task using the group selected option for task completion can be provided via the digital conversational bot.

### BACKGROUND

Computer conversation platforms have been used for communicating between computer-readable profiles (such as user profiles) using natural language data. For example, such natural language data may be in the form of data representing natural language text or data representing audible speech. Digital conversational bots have been used to converse with profiles on such platforms. As used herein, the term digital refers to being computerized, such as a digital computer component, which is part of a computer system, or digital data, which is computer-readable data that is useable in a computer system. A digital conversational bot is a computing component that is programmed to receive and analyze natural language data, such as scripts from computer-readable profiles, and to respond with natural language scripts. The received data and the resulting natural language scripts can be in various forms that can be processed in computer systems, such as data representing text and/or data representing audible speech.

Groups of computer-readable profiles are able to participate in group conversations on conversation platforms between two or more such profiles. In a group conversation, communications from each profile that is a member of the group are distributed to other members of the group by the conversation platform. For example, such group conversations may include group textual messaging, group audio calls, and/or group video calls. Conversations on such platforms can include a variety of different topics, such as discussing social matters, discussing business matters, and/or discussing how to complete a task.

### SUMMARY

The tools and techniques discussed herein relate to computerized group task digital assistance. For example, such digital assistance can include joining a digital conversational bot into a group online conversation, and involving the digital conversational bot in providing assistance to the profiles in the conversation with completing a task.

In one aspect, the tools and techniques can include joining a digital conversational bot in a natural language group conversation between profiles over a computer conversation platform. A recommendation option set of multiple options can be generated from an initial option set. The generating can include analyzing the initial option set using individual data of the profiles pertaining to the task. Also, a natural language script can be generated and transmitted to the profiles via the digital conversational bot as part of the group conversation, with the natural language script describing the options of the recommendation option set. A group consensus of the profiles in selecting a group selected option from the recommendation option set can be facilitated via the digital conversational bot. Additionally, assistance in completion of the task using the group selected option for task completion can be provided via the digital conversational bot.

In another aspect of the tools and techniques, participation via a computing device, in a computerized natural language group conversation between a plurality of profiles over a computer conversation platform can be performed. A digital communication can be received from the computer conversation platform. The communication can indicate that a digital conversational bot is joining in the group conversation to assist in completion of a task for the profiles. An indication that the digital conversational bot is joining in the group conversation to assist in completion of the task can be presented. A recommendation option set can be processed, with the recommendation option set including multiple options that are personalized to the profiles. The options of the recommendation option set can be presented on the computing device. Selection input can be processed on the computing device, with the selection input selecting an option from the recommendation option set for a profile of the profiles in the group conversation. The selection input can be forwarded to the computer conversation platform. One or more messages from the digital conversational bot can be processed, with the one or more messages indicating selections of options from the recommendation option set from profiles in the group conversation. The selected options can be presented on the computing device as part of the group conversation. An indication of a group consensus of the profiles in selecting a group selected option from the selected options can be processed, and can be presented. Additionally, computerized assistance from the digital conversational bot in completion of the task using the group selected option for task completion can be received via the computing device.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described aspects may be implemented.

FIG. 2 is a schematic diagram of a group task digital assistance system.

FIG. 3 is a flowchart of a computerized group task digital assistance technique.

FIG. 4 is a flowchart of another computerized group task digital assistance technique.

### DETAILED DESCRIPTION

Aspects described herein are directed to techniques and tools for computerized assistance in completion of group tasks. Such improvements may result from the use of various techniques and tools separately or in combination.

Use of computer conversation platforms (such as audible and/or textual messaging applications and/or services) for communicating between profiles such as user profiles is increasing. As used herein, a profile is a computer-readable set of data that indicates characteristics of an entity represented by the profile. For example, a user profile can include data that indicates characteristics of a user or group of users, such as contact information, preferences, and/or other individual data for the user or group of users. As used herein, a profile can be said to perform an act if the act is performed by one or more computer components for the profile, or while the profile is active in the computer system so that the acts are attributed to the profile (such as where the profile is logged in to a computer environment and acts are performed in that computer environment for the profile, which may be at the direction of user input associated with the profile).

Groups of users, with varying interests and preferences have used conversation platforms to discuss the completion of tasks, like planning an outing, using their user profiles. With such use, the actual task itself is completed outside of the conversational paradigm, though often using computer components, such as by using dedicated task completion computer applications, browsers, and/or other computer components.

The tools and techniques discussed herein may include providing digital assistance for task completion, which can include arriving at selected options for completing a task, and the completion of the task itself using the identified options. The entire task completion can involve understanding user preferences of the group, identifying the right suggestions/activities that are of broader appeal, and actual task completion.

The tools and techniques herein can improve efficiency and effectiveness of task completion, through the use of a digital conversational bot in a group conversation. The digital conversational bot, when joined into these multi-profile conversations can help with task completion through its ability to perform one or more of the following: understand the semantics and context of the conversation; identify personal preferences of individual profiles (which can reflect preferences of users of those profiles) for that particular task and/or topic; provide recommendations that are of common interest to the profile group; ability to provide voting and consensus building measures towards arriving at a decision on how to accomplish the task; and/or linking to other computer components for task completion. The tools and techniques can effectively and efficiently assist a set of profiles with task completion, keeping the needs and preferences of the profiles in the group in mind.

As an example of computerized assistance in completion of group tasks, consider multiple friends trying to plan and book tickets for a movie. The digital conversational bot can access data indicating preferences of individual profiles of the users in the group around movie language, movie genre, movie artists, movies already seen, location of each user, and other individual data. Based on this individual data, the digital conversational bot can recommend movies that are suited for the group, and can provide assistance to arbitrate choice conflict of users participating in group conversation. A computer system implementing these tools and techniques can protect users' data and can make sure that individual users are allowed to provide input on the involved level of sharing of data, such as sharing of preferences in the group conversation. The digital conversational bot can also provide the ability for the users to vote for options, and the bot can provide detailed information on options, thereby facilitating consensus building. Based on the consensus, an option for task completion (such as an option that include the event, timing, and venue) can be decided. Further, the digital conversational bot can assist in booking an event via a third party, and may further assist with related items such as booking transportation to an event. The tools and techniques discussed herein may provide assistance for many other types of tasks as well, such as a group working on agreeing upon an item to purchase, and making the purchase; agreeing upon details for a meeting and booking a venue for the meeting; agreeing on a restaurant and booking a reservation for the restaurant; agreeing on an investment option (what to invest in, how much to invest, etc.) and investing money according to the investment option; and any of many other types of group tasks.

Such tools and techniques can improve the effectiveness and efficiency of a computer system in facilitating task completion. For example, the use of the digital conversational bot can cut down on the amount of conversational messages that would otherwise be sent over a computer system in discussing and identifying different options for task completion, and in invoking different components outside the conversation platform for task completion. Additionally, the use of the digital conversational bot can make the computer system a more effective tool for completing group tasks, such as by identifying and coming to consensus on options for task completion that may not otherwise have been identified or agreed upon without the aid of the digital conversational bot.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

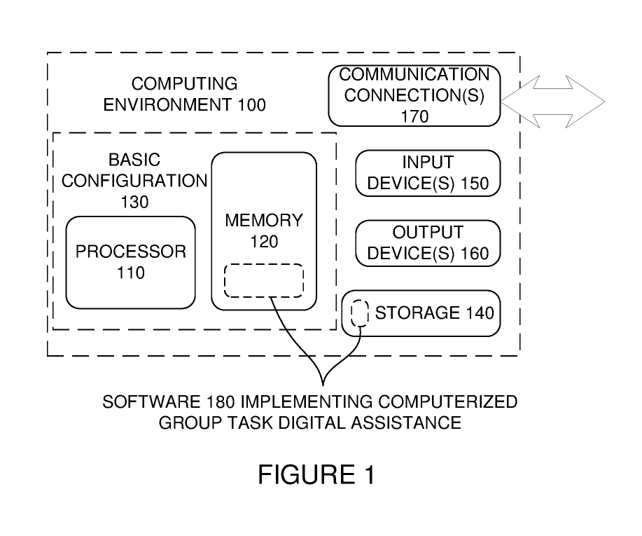

Techniques described herein may be used with one or more of the systems described herein and/or with one or more other systems. For example, the various procedures described herein may be implemented with hardware or software, or a combination of both. For example, the processor, memory, storage, output device(s), input device(s), and/or communication connections discussed below with reference to FIG. 1 can each be at least a portion of one or more hardware components. Dedicated hardware logic components can be constructed to implement at least a portion of one or more of the techniques described herein. For example and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

FIG. 1 illustrates a generalized example of a suitable computing environment (100) in which one or more of the described aspects may be implemented. For example, one or more such computing environments can be used as a client computer device and/or a server computer device in a client-server group task assistance system, or a peer device in a peer-to-peer computer system configuration. Generally, various different computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse types of computing environments.

With reference to FIG. 1, various illustrated hardware-based computer components will be discussed. As will be discussed, these hardware components may store and/or execute software. The computing environment (100) includes at least one processing unit or processor (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing computerized group task digital assistance. An implementation of computerized group task digital assistance may involve all or part of the activities of the processor (110) and memory (120) being embodied in hardware logic as an alternative to or in addition to the software (180).

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more aspects of the technology discussed herein. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The memory (120) can include storage (140) (though they are depicted separately in FIG. 1 for convenience), which may be removable or non-removable, and may include computer-readable storage media such as flash drives, magnetic disks, magnetic tapes or cassettes, CD-ROMs, CD-RWs, DVDs, which can be used to store information and which can be accessed within the computing environment (100). The storage (140) stores instructions for the software (180).

The input device(s) (150) may be one or more of various different input devices. For example, the input device(s) (150) may include a user device such as a mouse, keyboard, trackball, etc. The input device(s) (150) may implement one or more natural user interface techniques, such as speech recognition, touch and stylus recognition, recognition of gestures in contact with the input device(s) (150) and adjacent to the input device(s) (150), recognition of air gestures, head and eye tracking, voice and speech recognition, sensing user brain activity (e.g., using EEG and related methods), and machine intelligence (e.g., using machine intelligence to understand user intentions and goals). As other examples, the input device(s) (150) may include a scanning device; a network adapter; a CD/DVD reader; or another device that provides input to the computing environment (100). The output device(s) (160) may be a display, printer, speaker, CD/DVD-writer, network adapter, or another device that provides output from the computing environment (100). The input device(s) (150) and output device(s) (160) may be incorporated in a single system or device, such as a touch screen or a virtual reality system.

The communication connection(s) (170) enable communication over a communication medium to another computing entity. Additionally, functionality of the components of the computing environment (100) may be implemented in a single computing machine or in multiple computing machines that are able to communicate over communication connections. Thus, the computing environment (100) may operate in a networked environment using logical connections to one or more remote computing devices, such as a handheld computing device, a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various aspects. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Computerized Group Task Digital Assistance System

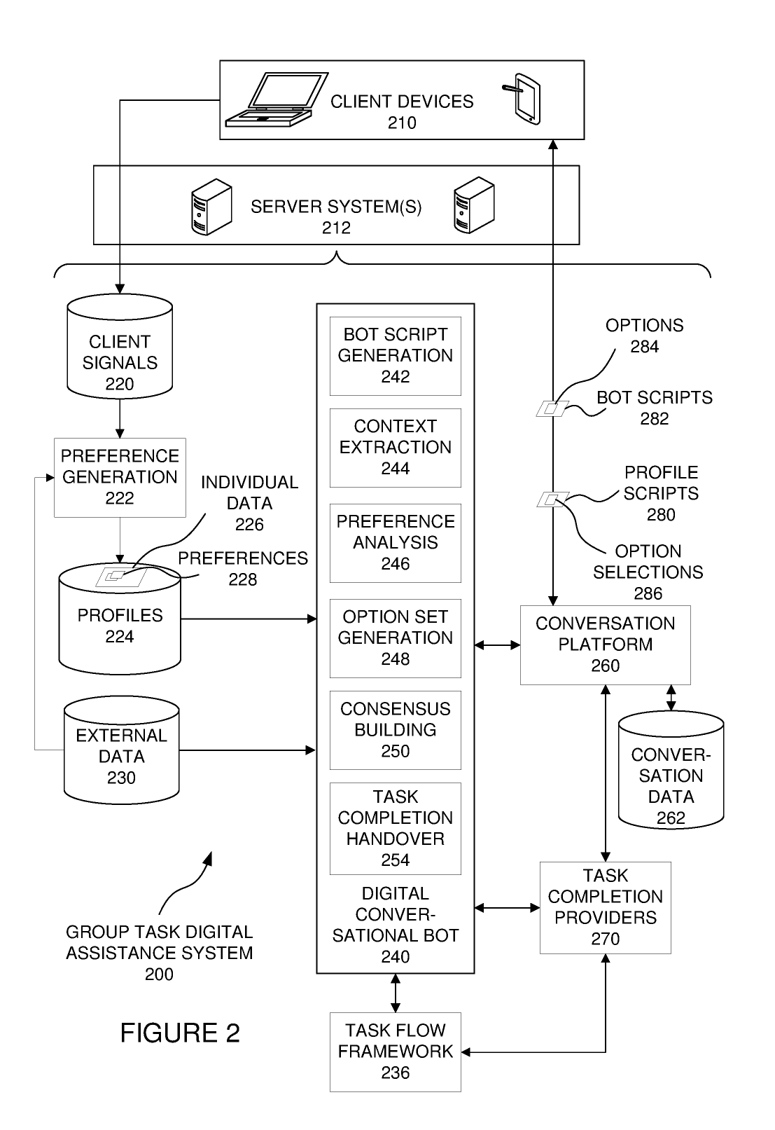

FIG. 2 is a schematic diagram of a computerized group task digital assistance system (200) in conjunction with which one or more of the described aspects may be implemented.

Communications between the various devices and components discussed herein can be sent using computer system hardware, such as hardware within a single computing device, hardware in multiple computing devices, and/or computer network hardware. A communication or data item may be considered to be sent to a destination by a component if that component passes the communication or data item to the system in a manner that directs the system to route the item or communication to the destination, such as by including an appropriate identifier or address associated with the destination. Also, a data item may be sent in multiple ways, such as by directly sending the item or by sending a notification that includes an address or pointer for use by the receiver to access the data item. In addition, multiple requests may be sent by sending a single request that requests performance of multiple tasks.

Each of the components of the computerized group task digital assistance system (200) of FIG. 2 includes hardware, and may also include software. For example, a component of FIG. 2 can be implemented entirely in computer hardware, such as in a system on a chip configuration. Alternatively, a component can be implemented in computer hardware that is configured according to computer software and running the computer software. The components can be distributed across computing machines or grouped into a single computing machine in various different ways. For example, a single component may be distributed across multiple different computing machines (e.g., with some of the operations of the component being performed on one or more client computing devices and other operations of the component being performed on one or more machines of a server).

A. System Overview

The components of the computerized group task digital assistance system (200) of FIG. 2 will be briefly discussed in this subsection. Each of the components will then be discussed in more detail in the subsection that follows this one.

The assistance system (200) can include client devices (210), which can include various different types of devices, which may interact with users (not shown) to present data and to receive input that can be processed. The client devices (210) can interact with one or more server systems (212), which can include server computer components. Such components can include a store of client signals (220), a preference generation component (222), and a store of profiles (224). The profiles (224) can include individual data (226), which can include preferences (228). The server system(s) (212) can also include a store of external data (230).

The server system(s) (212) can include a task flow framework (236), which can manage an overall flow of control for assisting in task completion. The task flow framework (236) can interact with a digital conversational bot (240) of the server system(s) (212). The individual data (226) and the external data (230) can be transmitted to the digital conversational bot (240). The digital conversational bot (240) can include a bot script generation component (242), a context extraction component (244), a preference analysis component (246), a consensus building component (250), and a task completion handover component (254).

The digital conversational bot (240) can interact with a conversation platform (260) of the server system(s) (212), which can access a store of conversation data (262). The digital conversational bot (240), the task flow framework (236) and/or the conversation platform (260) can interact with task completion providers (270) of the server system(s) (212) for task completion. Also, the conversation platform (260) can interact with the client devices (210) to transmit and receive data, such as profile scripts (280) and bot scripts (282). The bot scripts (282) can include options (284) for task completion, and the profile scripts (280) can include option selections (286).

One or more of the components of the group task digital assistance system (200) may be shared with, or overlap with, one or more other components or systems.

B. System Component Details

Referring still to FIG. 2, each of the components of the group task digital assistance system (200) will be discussed in more detail. The client devices (210) and the computer machines of the server system(s) (212) can include various different types of computer devices, such as the types of devices discussed above with reference to FIG. 1. Data transmitted between the components of FIG. 2 can be transmitted in different ways, such as over computer networks and/or within computing machines.

The client signals (220) can be provided by the client devices (210) and/or extracted from server system(s) (212). For example, such client signals (220) may include data corresponding to the profiles (224), indicating data for each such profile, such as online browsing data, online search data, application usage data, data from online storage or communication services, location data, data from online shopping, and so forth. Such data may include personal information, and such data can be appropriately treated and safeguarded. For example, such data can be protected with security measures such as data encryption and the use of keys and certificates when transmitting the data. Also, some particularly sensitive data may be deleted and/or not collected. Users of the profiles (224) may control how their data is handled by providing appropriate settings, such as opt-in and/or opt-out settings.

The external data (230) can include many different types of data other than the data in the client signals (220). Such external data (230) may include data regarding the available task completion providers (270), data regarding events, data regarding locations (e.g., map data and address data), data for user reviews, and/or other external data. The store of external data (230) may be, for example, a data store associated with an existing general online search engine, and/or some other online service(s) with data relevant to types of tasks with which the digital conversational bot (240) is programmed to assist.

The client signals (220) can be processed by the preference generation component (222) to generate the preferences (228) of particular profiles (224), which can include inferring the preferences (228) from the client signals (220) and/or the external data (230). As used herein, the preferences are stored computer-readable data that indicates likely preferences, as inferred from available data. The preference generation component (222) can use multiple existing computer data processing techniques in generating the preferences (228). For example, the preference generation component (222) can utilize data mining of the overall client signals (220) and the external data (230) to extract meaningful data from which to infer the preferences (228). The preference generation component (222) can also employ statistical reasoning, and machine learning using feedback loops to infer preferences (228) from the data extracted from the client signals (220) and the external data (230).

The generation of preferences (228) can be done in an offline manner, such as being performed on a regular basis using available updated data for available profiles (224). The preferences (228) can be stored in data structures that connect each profile (224) with its corresponding preferences (228). Thus, the preferences (228) can be considered to be part of the profiles (224). This can be true whether the preferences (228) are actually stored within the profiles (224) in a continuous memory location, or if there is some other data structure employed to connect the preferences (228) with corresponding profiles (224), such as pointers within the profiles (224) that point to the corresponding preferences (228), or look-up tables that list profiles (224) and corresponding preferences (228), etc.

As an example of a preference generation, the client signals (220) may reveal that a profile (224) is listed as attending many movies with a particular lead actor. For example, some data may indicate that the profile (224) booked a movie ticket with a theatre, other data may indicate that the profile (224) has reserved DVD rentals, and other data may indicate that the profile (224) has live streamed movies. The preference generation component (222) can mine all of that data to infer which movies have been viewed, and can use data mining of the external data (230) for those movies to determine which actors and actresses were in the viewed movies for the profile (224). Finally, the preference generation component (222) can use statistical reasoning to determine a level of affinity between the profile (224) and the actors, actresses, and movie genres of the movies, as well as affinities of the profile (224) for particular online movie streaming services, movie rental services, and movie theatres. Such statistical reasoning can yield resulting preferences (228), and the preferences can include indications of the strengths of the preferences (228). For example, each preference (228) can include a strength score from the statistical analysis that resulted in the identification of the preference. For example, viewing an overall greater number of movies by a particular actor may increase the preference strength score for movies with that actor, and viewing a larger percentage of movies may also increase the preference score for movies with that actor.

The profiles (224) can also include other individual data (226) in addition to the preferences (228). For example, the individual data (226) could include a home address and/or a work address for a user corresponding to a profile.

Referring still to FIG. 2, the context extraction component (244) of the digital conversational bot (240) can be programmed to receive and extract meaningful data from profile scripts (280) for a group conversation on the conversation platform (260). The script generation component (242) can generate bot scripts (282) and send such scripts to the conversation platform (260) to be forwarded by the conversation platform (260) to the client devices (210) involved in the group conversation. For example, the digital conversational bot (240) can exchange data with the conversation platform (260) using an application programming interface.

The context extraction component (244) can utilize existing natural language understanding computer components, which can receive the profile scripts (280) and generate useable data from the profile scripts using language analysis techniques such as keyword and/or phrase matching techniques. The context extraction component (244) may include one or more known components for understanding natural language in the profile scripts (280). For example, such natural language understanding component(s) may utilize a lexicon of the natural language, as well as a parser and grammar rules to break each natural language phrase into a data representation of the phrase. The language understanding component(s) may also utilize a semantic theory to guide comprehension, such as a theory based on naïve semantics, stochastic semantic analysis, and/or pragmatics to derive meaning from context. Also, the language understanding component(s) may incorporate logical inference techniques by mapping a derived meaning into a set of assertions in predicate logic, and then using logical deduction to arrive at conclusions as to the meaning of the text. Using results of such language understanding techniques, the context extraction component (244) can provide resulting data to one or more of the other components of the digital conversational bot (240) to perform one or more acts, such as generating bot scripts (282), analyzing preferences, generating option sets, building consensus, or handing over a task for completion.

As noted, based on such extracted meanings from the context extraction component (244), the bot script generation component (242) can form natural language scripts to be provided as bot scripts (282) in a group conversation. For example, such bot scripts may be generated by matching determined meanings from the received profile scripts (280) with templates for responses. Such templates may include placeholders to be filled with information from the other components of the digital conversational bot (240).

The context extraction component (244) can extract from the profile scripts (280) an inferred meaning that the profiles (224) in a group conversation are seeking to accomplish a task with which the digital conversational bot (240) can assist. For example, the context extraction component (244) may send a request to the conversation platform (260) for the conversation data (262), which can include profile scripts (280) from the conversation. Alternatively, the context extraction component (244) may retrieve the profile scripts (280) in some other way, such as by continually monitoring the profile scripts (280) of each active group conversation on the conversation platform (260). The context extraction component (244) can also identify the type of task. In an example of a group of profiles selecting a movie, the context extraction component (244) may determine from the profile scripts (280) in the group conversation that the profiles (224) are working to buy tickets to see a movie in a theatre. Such a meaning may be inferred from discussions between the profiles (224). For example, the profile scripts (280) may state, “We should go see a movie?”, and “Okay, what movie should we see?” In other examples, a profile (224) in the group may directly request assistance, such as by selecting a displayed control on a display screen, or making a statement, such as, “Bot, please help us get tickets for a movie.” The extracted information on the identified type of task, and other contextual information can be provided by the context extraction component (244) to other components in the digital conversational bot (240).

The context extraction component (244) may also extract other contextual data in addition to the meanings from the profile scripts (280) themselves. For example, data indicating the locations of the client devices (210) may be retrieved from the conversation platform (260), where such data may be retrieved from the client devices (210) (such as by the client devices (210) providing global positioning system data) and included in the conversation data (262). Other data that may be used for context extraction could include the current time and date. The extracted context data from the context extraction component (244) can be passed on to the other components of the digital conversational bot (240) for performance of techniques by those components, and also to the task flow framework (236) for managing the overall flow of the assistance with an identified task.

For example, the extracted context from the context extraction component (244) may indicate that the group of profiles at different locations in City A desire to buy movie tickets for the corresponding users to attend a movie theatre together that evening. The digital conversational bot (240) can use such information to request that the preference analysis component (246) analyze personal information of the profiles relevant to movies, and to movie theatres. The preference analysis component (246) can analyze the individual data (226) of the profiles (224) in the group, including the preferences (228) of the profiles related to movies and movie theatres. Such preferences and other individual data for the profiles (224) related to the task identified by the context extraction component (244) can be output by the preference analysis component (246). For example, for each of the profiles (224) the preference analysis component (246) can provide a set of preferences and corresponding preferences strengths, such as preferences for movie genres, movie actors and/or actresses, and movie theatres. The preference analysis (246) may also consider individual data such as which particular movies are indicated as already having been seen by the user corresponding to each particular profile (so that such movies can be scored lower).

The personalized information on the profiles (224) in the group conversation can be provided from the preference analysis component (246) to the option set generation component (248). The option set generation component (248) can use such preference analysis data and external data (230) to generate a recommended set of options (284) for completing the identified task. To do this, the option set generation component (248) can retrieve an initial options set including possible options from the store of external data (230).

The task flow framework (236) may assist in identifying the available options, such as by identifying potential service providers for sets of profiles (224) in a group conversation. For example, the task flow framework (236) can be programmed with data for such service providers, or may be programmed to mine such data from the external data (230), such as by sending queries to a search engine regarding available service providers for particular services. The data received by the task flow framework (236) may include information that can assist in selecting a provider, such as geographic limitations, data regarding services provided, and other data. As an example, for a Website that sells movie tickets for movie theatres, the data for the Website can indicate which movie theatres are serviced by that Website. The option set generation component (248) may limit its requests for data to relevant data for the identified task. Also, the set generation component (248) can analyze this information to produce a recommended set of options (284). In doing so, the set generation component (248) may filter relevant data (by including limitations in queries for data and/or by filtering received data). The set generation component (248) may also rank the recommended options. Such ranking can include applying multiple weighted factors to produce ranking scores. As a few examples, the factors may include relative distances from locations such as the current locations of the client devices (210), relative distances from home and/or work locations, alignment of the options with the preferences (228) of the profiles (224) in the group conversation, and so forth.

Continuing the movie ticket example above, the option set generation component (248) may request from the store of external data (230), data on movie theatres in City A. This requested data may include addresses and user ratings of the theatres, and data on movies playing in those theatres in the coming evening, including genres of the movies, user ratings of the movies, and actors and actresses in the movies. The set generation component (248) can score how closely such data for each of the options in this initial option set (with each option being a particular movie playing at a particular time in a particular theatre) matches the individual data (226) for the profiles (224) and the contextual data for the group conversation. For example, a movie option may score higher based on one or more of the following: an actor or actress in the movie is preferred in the preferences (228) of a profile (224) in the group (with a higher score for a stronger preference); a movie genre for the movie is preferred in the preferences (228) of a profile (224) in the group (with a higher score for a stronger preference); the movie theatre is preferred in the preferences (228) of a profile (224) in the group (with a higher score for a stronger preference); the movie time is open on a profile's calendar in the individual data (226); the distance from a client device (210) for a profile (224) in the group to the movie theatre is relatively less than other options; the distance from a home location for a profile (224) in the group to the movie theatre is relatively less than other options; the distance from a work location for a profile (224) in the group to the movie theatre is relatively less than other options; the movie has a large number of user reviews; the movie has high favorable ratings in its user reviews (such as how many stars out of five stars on average); and/or the movie theatre has a large number of user reviews. Other factors may favor variety in the options, with options that are substantially different from other options receiving higher scores. Different weights can be assigned to the factors. For example, such weights may initially be assigned by an administrative user of the digital conversational bot (240), and such weights may be trained with live feedback and/or with training data to refine the weights and/or to change which factors are considered. Such training may be done in a manner similar to training of search engine ranking factor weights. Also, different sets of factors may be used for different tasks. For example, the factors for scheduling a business meeting can be different from the factors for booking movie tickets, and the factors for making a purchase can be different from either of the foregoing types of tasks.

Using the option scores, the options in the initial set can be ranked. The highest scoring options may be presented more prominently (such as by being listed first), and also the number of options (284) in the recommended set may be limited to a predetermined number of the highest scoring options (such as the top ten scoring options).

Other ways of choosing the recommended options may be used in addition to or instead of the scoring technique discussed above. For example, the initial set of options may be taken through a series of filtering steps, such as to filter out options with locations that are farther than a predetermined distance from a geographic location, or options with user reviews that are below a set minimum rating. The option set generation component (248) can provide a recommended option set to the bot script generation component (242) for inclusion in one or more bot scripts (282). Such a bot script (282) with recommended options (284) can be sent to the conversation platform (260), and the conversation platform (260) can send the bot script (282) with the recommended options (284) to the client devices (210) for the profiles (224) in the group conversation.

The consensus building component (250) can assist the profiles (224) in coming to a consensus on which option from the recommended set of options (284) to use in completing an identified task for the group. For example, the bot script (282) that includes the recommended set of options (284) can also request that the profiles (224) vote on the options (284). For example, each of the profiles (224) can select an option on a displayed control for voting, or can send a profile script (280) that includes an option selection (286). For example, a profile (224) can provide an audio or textual message that says, “I want to see Movie X at Theatre A and 6:00 PM,” or “Option 2”, where option 2 is Movie X at Theatre A and 6:00 PM. Such a script can be understood by the context extraction component (244) of the digital conversational bot (240) using natural language understanding techniques, as with understanding of other profile scripts (280) discussed herein.

The consensus building component (250) can quantify the option selections (286) from the profiles (224), selecting options from the initial set of options (284). In some implementations, the consensus building component (250) may provide results of such quantifying to the bot script generation component (242) to include the results in a bot script (282) to be sent to the profiles (224) in the group. For example, the results can list the selected options and may also include other information related to the options, such as explanations as to why such options may be desirable or undesirable choices. This bot script (282) listing the selected set of options (284) can also invite the profiles (224) in the group to indicate the group's choice of an option from the set of selected options. This bot script (282) can also include additional information, such indicating which profile(s) selected which option (284), and/or information about one or more of the profiles' preferences (228). For example, the bot script (282) with the selected set of options (284) may state, “Movie A is an action movie, and each member of the group has watched action movies at least 50% of the time.” Such information may help the profiles (224) reach a consensus on a single option (284). Additionally, the consensus building component (250) may also rank the options (284) in the set of selected options, and the set of selected options may be provided in the bot script (282) in the ranked order.

The ranking of the selected options set can be performed in a manner similar to the ranking of the recommended options set discussed above. The ranking of the selected option set can also consider the option selections (286) of the profiles (224), such as by giving relatively higher rankings to options (284) with more option selections (286) (so that votes from more profiles (224) raise the ranking of an option (284) in the selected options set). Also, weighting of at least some factors may be different for the ranking of the selected options set, as compared to the recommended options set. As discussed above, such weights for different factors may be set by an administrative user initially, and then trained using feedback data, such as in a manner similar to how weights are trained in search engine ranking.

Upon receiving a list of selected options (284) in the selected options set, the profiles (224) in the group can discuss the selected options (284) using profile scripts (280) (such as audio natural language and/or textual natural language scripts), and come to a consensus on a particular option (284) from the selected options set. One or more of the profiles can indicate this group selected option (284) to the digital conversational bot (240), such as by sending a profile script (280) from a client device (210), or selecting a displayed control on a client device (210), which can trigger corresponding data to be sent to the digital conversational bot (240).

Upon receiving data indicating the group selection of an option (284), the digital conversational bot (240) can assist in completion of the task. As noted above, the group digital assistance system (200) can include a task flow framework (236), which can manage the overall flow of the operations discussed above for the components of the digital conversational bot (240).

As noted above, the task flow framework (236) can include data about service providers that can be used in completing tasks, i.e., the task completion providers (270). This information can include data revealing tools and techniques for interacting with the task completion providers to complete tasks, such as data revealing an application ecosystem for one or more such task completion providers (270) (so that interaction can be done through one or more applications), deep linking with the task completion providers (270) to accomplish tasks, and data indicating how delegation to task completion providers (270) can be performed.

The task flow framework (236) can use such data regarding the task completion providers (270) to work with the task completion handover component (254) of the digital conversational bot (240) to identify a task completion provider (270) to complete the task using the group selected option (284). The task completion handover component (254) can pass the needed data to the task completion provider (270) to assist in the completion of the task, such as data on the group selected option (284), the current context of the group conversation from the conversation data (262), and information on preferences (228) (e.g., preferences for seat locations, etc.). Completion of the task using a task completion provider may utilize additional input from the group conversation profiles (224). Such input may be provided directly from the client device(s) (210) to the selected task completion provider (270), and/or through the conversation platform (260) as part of the group conversation. For example, additional payment information (credit card information, for example) may need to be provided. In handling such information, as with other information discussed herein, privacy can be protected according to security and privacy practices in the group task digital assistance system (200).

The task completion providers (270) may be closely linked to other components in the group task digital assistance system (200), such as where deep linking is provided between components that are all managed by a single entity. Alternatively, the task completion providers (270) may be managed and operated separately from the conversation platform (260), the digital conversational bot (240), and/or the task flow framework (236). In any event, data can be sent via existing computer communication techniques to the task completion providers (270) by the task completion handover component (254) and/or the task flow framework (236) to assist in completing the task.

### III. Computerized Group Task Digital Assistance Techniques

Several computerized group task digital assistance techniques will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable memory may have computer-executable instructions embodied thereon that, when executed by at least one processor, cause at least one processor to perform the technique. The techniques discussed below may be performed at least in part by hardware logic.

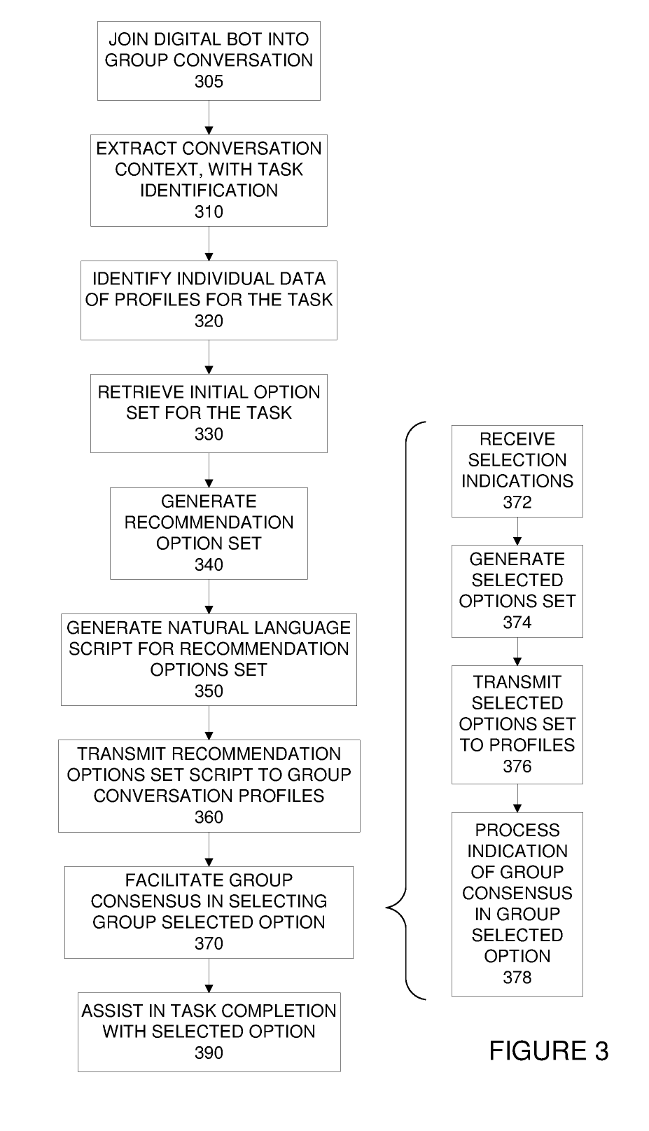

Referring to FIG. 3, a computerized group task digital assistance technique will be described. The technique may include some or all of the acts discussed below with reference to FIG. 3. The technique can include joining (305) a digital conversational bot to participate in a computerized natural language group conversation between a plurality of computer-readable profiles over a computer conversation platform. Such joining (305) can include setting up configurations to allow the digital conversational bot to participate in the group conversation, similar to joining a user profile to a group conversation. The technique can also include extracting (310) context of the conversation from natural language data of the conversation (possibly also using other data as well), with the extracting including identifying a task to be performed for the profiles with assistance from the digital conversational bot. Computer-readable individual data can be identified (320), with the individual data pertaining to the identified task. An initial option set of alternative computer-readable options for completion of the task can be identified (320). The technique can further include retrieving (330) an initial option set of alternative computer-readable options for completion of the task. A recommendation option set of multiple options from the initial option set can be generated (340). The generating (340) can include analyzing the initial option set using the individual data of the profiles pertaining to the task. Also, a natural language script can be generated (350) via the digital conversational bot, with the natural language script describing the options of the recommendation option set. The natural language script can be transmitted (360) via the digital conversational bot to the profiles in the group conversation over the computer conversation platform. A group consensus of the profiles in selecting a group selected option from the recommendation option set can be facilitated (370) via the digital conversational bot. Additionally, the technique of FIG. 3 can include assisting (390), via the digital conversational bot, in completion of the task using the group selected option for task completion. This technique can be implemented with one or more of the features that is each set forth in a paragraph below regarding the technique of FIG. 3, in any combination of the features.

The facilitating (370) of the group consensus can include one or more of the acts discussed in this paragraph. Indications that each indicate a selection of an option from the recommendation option set by one of the profiles can be received (372) via the digital conversational bot. A selected options set that includes selected options indicated in the selection indications can be generated (374). The selected options set can be transmitted (376) via the digital conversational bot to the profiles as part of the group conversation. An indication of a group consensus of the profiles in selecting a group selected option from the selected options can be processed (378) via the digital conversational bot.

The individual data can include preference data, which indicates preferences of the profiles pertaining to the task. The generating (340) of the recommendation option set and/or the generating (374) of the selected options set can include analyzing the options using the preferences of the profiles pertaining to the task.

The individual data can include location data indicating geographic locations for the profiles (e.g., current device locations, home locations, and/or business locations). The generating (340) of the recommendation option set and/or the generating (374) of the selected options set can include analyzing options using the location data for the profiles and location data for the options in the initial option set or the selected options set, respectively.

The generating (340) of the recommendation option set and/or the generating (374) of the selected options set can include analyzing data indicating quality of the options being analyzed, such as data indicating user review ratings.

The generating (340) of the recommendation option set and/or the generating (374) of the selected options set can include ranking options using factors, such as one or more of the following: preference data indicating preferences of the profiles pertaining to the task; location data indicating geographic locations for the profiles; and/or data indicating quality of options. For the generating (374) of the selected options set, this ranking can include using the selection indications as a factor in the ranking of the selected option set.

The assisting (390) in task completion can include identifying a task completion computing component (such as one of the computerized task completion providers discussed above) and initiating a task completion process with the task completion computing component.

The assisting (390) can include sending data to the task completion computing component, with the data sent to the task completion computing component indicating a feature derived from the group selected option.

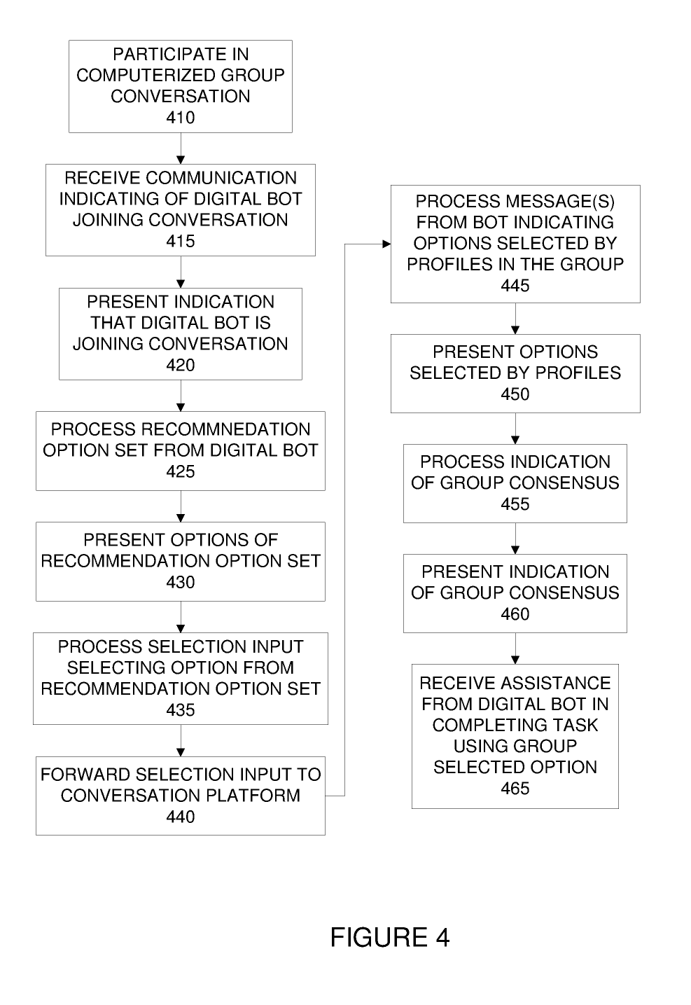

Referring now to FIG. 4, another computerized group task digital assistance technique will be discussed. The technique can include participating (410) via a computing device, in a computerized natural language group conversation between a plurality of computer-readable profiles over a computer conversation platform. A digital communication can be received (415) from the computer conversation platform. The communication can indicate that a digital conversational bot is joining in the group conversation to assist in completion of a task for the profiles. In response to the receiving (415) of the communication, an indication that the digital conversational bot is joining in the group conversation to assist in completion of the task can be presented (420). A recommendation option set can be processed (425), with the recommendation option set including multiple options that are personalized to the profiles. The options of the recommendation option set can be presented (430) on the computing device. Selection input can be processed (435) on the computing device, with the selection input selecting an option from the recommendation option set for a profile of the profiles in the group conversation. The selection input can be forwarded (440) to the computer conversation platform. As with other instances of sending or otherwise processing data discussed herein, the selection input can still be considered to be the same data if it is transformed to another form (such as still being the same selection input, even if it changed from a form of input passed through a software and/or hardware stack for a touch screen on a computer device, to data sent in a message in one or more data packets over a computer network). One or more messages from the digital conversational bot can be processed (445), with the one or more messages indicating selections of options from the recommendation option set from profiles in the group conversation. In response to the processing, the selected options can be presented (450) on the computing device as part of the group conversation. An indication of a group consensus of the profiles in selecting a group selected option from the selected options can be processed (455), and in response to the processing (455), can be presented (460). Additionally, computerized assistance from the digital conversational bot in completion of the task using the group selected option for task completion can be received (465) via the computing device.

Presenting the selected options (or presentation of other options discussed herein) can include audibly speaking the selected options using the computing device. Alternatively, presenting the selected options (or presentation of other options discussed herein) can include displaying the selected options on a computer display.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A computer system comprising:
at least one processor; and
memory comprising instructions stored thereon that when executed by at least one processor cause at least one processor to perform acts comprising:
joining a digital conversational bot to participate in a computerized natural language group conversation between a plurality of computer-readable profiles over a computer conversation platform;
extracting context of the conversation from natural language data of the conversation, with the extracting comprising identifying a task to be performed for the profiles with assistance from the digital conversational bot;
identifying computer-readable individual data of the profiles, with the individual data pertaining to the identified task;
retrieving an initial option set of alternative computer-readable options for completion of the task;
generating a recommendation option set of multiple options from the initial option set, with the generating of the recommendation option set comprising analyzing the initial option set using the individual data of the profiles pertaining to the task;
generating, via the digital conversational bot, a natural language script that describes the options of the recommendation option set;
transmitting, via the digital conversational bot, the natural language script to the profiles in the group conversation over the computer conversation platform;
receiving, via the digital conversational bot, selection indications that each indicate a selection of an option from the recommendation option set by one of the profiles;
generating a selected options set comprising selected options indicated in the selection indications;
transmitting, via the digital conversational bot, the selected options set to the profiles as part of the group conversation;
processing, via the digital conversational bot, an indication of a group consensus of the profiles in selecting a group selected option from the selected options; and
in response to the processing of the group consensus, assisting via the digital conversational bot, in completion of the task using the group selected option for task completion.

2. The computer system of claim 1, wherein the individual data comprises preference data indicating preferences of the profiles pertaining to the task, and wherein the identifying of the recommendation option set comprises analyzing the initial option set using the preferences of the profiles pertaining to the task.

3. The computer system of claim 1, wherein the individual data comprises location data indicating geographic locations for the profiles, and wherein the identifying of the recommendation option set comprises analyzing the initial option set using the location data for the profiles and location data for options in the initial option set.

4. The computer system of claim 1, wherein the generating of the recommendation option set comprises analyzing data indicating quality of options in the initial option set.

5. The computer system of claim 1, wherein the generating of the selected options set comprises ranking options in the selected options set using one or more of the following: preference data indicating preferences of the profiles pertaining to the task; location data indicating geographic locations for the profiles; and data indicating quality of options in the initial option set.

6. The computer system of claim 5, wherein the ranking of options in the selected options set further comprises using the selection indications as a factor in the ranking of the selected option set.

7. The computer system of claim 1, wherein the assisting comprises identifying a task completion computing component and initiating a task completion process with the task completion computing component.

8. The computer system of claim 7, wherein the assisting comprises sending data to the task completion computing component, with the data sent to the task completion computing component indicating a feature derived from the group selected option.

9. A computer-implemented method comprising the following acts:
joining a digital conversational bot to participate in a computerized natural language group conversation between a plurality of computer-readable profiles over a computer conversation platform;
generating a recommendation option set of multiple options from an initial option set, with the generating of the recommendation option set comprising analyzing the initial option set using individual data of the profiles pertaining to a task to be completed for the profiles;
generating, via the digital conversational bot, a natural language script that describes the options of the recommendation option set;
transmitting, via the digital conversational bot, the natural language script to the profiles in the group conversation over the computer conversation platform;
facilitating, via the digital conversational bot, a group consensus of the profiles in selecting a group selected option from the recommendation option set; and
assisting, via the digital conversational bot, in completion of the task using the group selected option for task completion.

10. The method of claim 9, wherein the facilitating of the group consensus comprises:
receiving, via the digital conversational bot, selection indications that each indicate a selection of an option from the recommendation option set by one of the profiles;
generating a selected options set comprising selected options indicated in the selection indications;
transmitting, via the digital conversational bot, the selected options set to the profiles as part of the group conversation; and
processing, via the digital conversational bot, an indication of a group consensus of the profiles in selecting a group selected option from the selected options.

11. The method of claim 10, wherein the generating of the recommended options set comprises ranking options in the recommended options set using one or more of the following: preference data indicating preferences of the profiles pertaining to the task; and location data indicating geographic locations for the profiles.

12. The method of claim 11, wherein the ranking of options in the recommended options set further comprises using data indicating quality of options in the recommended option set.

13. The method of claim 9, wherein the individual data comprises preference data indicating preferences of the profiles pertaining to the task, and wherein the generating of the recommendation option set comprises analyzing the initial option set using the preferences of the profiles pertaining to the task.

14. The method of claim 9, wherein the individual data comprises location data indicating geographic locations for the profiles, and wherein the generating of the recommendation option set comprises analyzing the initial option set using the location data for the profiles and location data for options in the initial option set.

15. The method of claim 9, wherein the generating of the recommendation option set comprises analyzing data indicating quality of options in the initial option set.

16. The method of claim 9, wherein the assisting comprises identifying a task completion computing component and initiating a task completion process with the task completion computing component.

17. The method of claim 16, wherein the assisting comprises sending data to the task completion computing component, with the data sent to the task completion computing component indicating a feature derived from the group selected option.

18. One or more computer-readable memory having computer-executable instructions embodied thereon that, when executed by at least one processor, cause at least one processor to perform acts comprising:
participating, via a computing device, in a computerized natural language group conversation between a plurality of computer-readable profiles over a computer conversation platform;
receiving from the computer conversation platform a digital communication indicating that a digital conversational bot is joining in the group conversation to assist in completion of a task for the profiles;
in response to the receiving of the communication, presenting an indication that the digital conversational bot is joining in the group conversation to assist in completion of the task;
processing a recommendation option set from the digital conversational bot, with the recommendation option set comprising multiple options that are personalized to the profiles;
presenting the options of the recommendation option set on the computing device;
processing selection input on the computing device, with the selection input selecting an option from the recommendation option set for a profile of the profiles in the group conversation;
forwarding the selection input to the computer conversation platform;
processing one or more messages from the digital conversational bot in the group conversation, with the one or more messages indicating selections of options from the recommendation option set from profiles in the group conversation;
presenting the selected options on the computing device as part of the group conversation;
processing, via the computing device, an indication of a group consensus of the profiles in selecting a group selected option from the selected options;
presenting the indication of the group consensus on the computing device as part of the group conversation; and
receiving via the computing device as part of the group conversation, computerized assistance from the digital conversational bot in completion of the task using the group selected option for task completion.

19. The one or more computer-readable memory of claim 18, wherein presenting the selected options comprises audibly speaking the selected options using the computing device.

20. The one or more computer-readable memory of claim 18, wherein presenting the selected options comprises displaying the selected options on a computer display.
